(19) United States
(12) Patent Application Publication
(10) Pub. No.: US 2006/0140071 A1
(43) Pub. Date: Jun. 29, 2006

(54) Objective lens optical part for optical pickup device and focusing method using the same

(76) Inventors: Yu-Tasang Hwang, Hsinchu (TW); Zu-Wen Chao, Hsinchu (TW)

Correspondence Address: RABIN & Berdo, PC, 1101 14TH STREET, NW, SUITE 500, WASHINGTON, DC, 20005, US

(21) Appl. No.: 11/188,904

(22) Filed: Jul. 26, 2005

(30) Foreign Application Priority Data
Dec. 23, 2004 (TW) 093140195

(51) Int. Cl. G11B 7/00

(52) U.S. Cl. 369/44.23; 369/112.01

(57) ABSTRACT

The present invention relates to an objective lens optical part for an optical pickup device and a focusing method using the same. The focusing method at least includes the steps of providing a first optical member and a second optical member corresponding to the first optical member, dividing a light source into a first optical beam and a second optical beam via the first optical member and the second optical member, and applying a random dithering mechanism to the second optical beam, such that respective pickup optical spot and tracking optical spot can be achieved, wherein the pickup spot picks up more data and the tracking optical spot facilitates tracking operation, thus improving tracking and accuracy of the picked up data.

### FIELD OF THE INVENTION

The present invention relates to an objective lens optical part and a focusing method using the same, and more specifically, to an objective lens optical part for an optical pickup device and a focusing method using the same.

### BACKGROUND OF THE INVENTION

An optical pickup device such as an optical pickup head is employed in a CD (Compact Disc) system or DVD (Digital Versatile Disc) system to generate light spot on the CD or DVD optical recording media for picking up data recorded in the optical recording media. Generally, a conventional optical system of an optical pickup device is as illustrated in FIG. 8.

Referring to FIG. 8, the optical system can be employed to pick up data in an optical recording medium 10. The optical system comprises a laser generator 20, a beam splitter 40, a collimator lens 50, an objective lens 60, and a beam detecting apparatus 70. The laser generator 20 is employed to generate laser beam for accessing the optical recording medium 10, such as a CD. The beam splitter 40 is employed to separate the laser beam from the reflected beam coming from the optical recording medium 10. The collimator lens 50 is employed to convert the laser beam into parallel beam. The objective lens 60 is employed to focus the parallel beam to the data face of the optical recording medium 10 for forming an accessing optical spot. The beam detecting apparatus 70 is employed to convert the reflected beam from the optical recording medium 10 into optical signal.

However, an ordinary optical recording medium is stored with data in very high density, width of track and space between the track are thus very small. At the same time, in order to rapidly and continuously pick up data, the optical recording medium per se must revolve at high speed. In addition, conventional substrate of the optical recording medium is made of transparent plastic material, which is susceptible to warping because of factors like external force or uneven distribution of environmental temperature etc. Furthermore, since the optical recording medium generally is replaceable, when it is inserted into a disc system such as a disc driver and the disc driver is activated, the rotational center of the optical recording medium is difficult to be superposed on the center of the data track.

Consequently, if the optical system slightly deviates from the track during pickup, tracking error will occur, therefore the data picked up may be incorrect, or even can not be picked up at all.

Besides generating optical spot and detecting reflected optical signal from the optical recording medium, the optical pickup device must also be able to target the optical spot at appropriate track; in other words, the optical pickup device must perform good tracking servo control to target the optical spot to the center of the track, therefore appropriately picking up data.

TW Patent Publication No. 511078 discloses an objective lens of an optical pickup head. As shown in FIG. 9, after going through the objective lens 60, the light beam is focused to the data face 101 of the optical recording medium 10 to form a smaller optical spot. The reflecting face of the objective lens frame 30 supporting the objective lens 60, which faces the direction of the light beam, is plated with metal layer 303 for changing the direction of the light beam. By taking advantage of near-field optical theory, the optical spot can be used for both pickup and tracking, and be projected to the center of the track 103. Although a small optical spot facilitates data pickup, however, it has problems in tracking.

Additionally, for the tracking servo controlling performed in present optical pickup device, analog tracking error signal is usually pre-converted into digital signal. However, in the course of the conversion, quantization error is often generated, which affects the correction of the servo. Consequently, if the optical spot for both pickup and tracking is too small, the quantization error will be greatly increased in the course of the analog to digital conversion of the tracking error signal, which adversely affects the tracking operation.

Therefore, there is a need to solve the aforementioned drawbacks of poor focus and tracking difficulties encountered in the prior art.

### SUMMARY OF THE INVENTION

Regarding the drawbacks of the above-mentioned conventional technologies, the primary objective of the present invention is to provide an objective lens optical part for an optical pickup device and a focusing method using the same for facilitating tracking and ensuring the accuracy of data pickup.

Another objective of the present invention is to provide an objective lens optical part for an optical pickup device and a focusing method using the same for improved design flexibility.

Still another objective of the present invention is to provide an objective lens optical part for an optical pickup device and a focusing method using the same for improved industrial usability.

In accordance with the above and other objectives, the present invention proposes an objective lens optical part for optical pickup device and a focusing method using the same. The objective lens optical part used to focus a light source to a data face and a track of an optical recording medium comprises: a first optical member comprising a hollow portion with an opening, a lateral surface opposing the opening, and a circumference surface neighboring the lateral surface, wherein the lateral surface allows at least a light source to pass through; a second optical member arranged in the hollow portion for dividing the light source passing through the lateral surface into a first optical beam refracted toward the circumference surface and a second optical beam refracted toward a rim of the opening; two reflective members respectively arranged at lateral sides of the circumference surface for focusing the first optical beam toward the data face of the optical recording medium; and a tracking mechanism comprising a refractive member arranged between the second optical member and the optical recording medium, and a driving member connecting with the refractive member for focusing the second optical beam toward the track of the optical recording medium.

It is preferred that the first optical member is a structure made of transparent plastic material. The hollow portion is a conical-shaped structure. The lateral surface of the first optical member is supported by an objective lens frame. Wherein, the first optical member can be selected to be arranged on an extending portion of the objective lens frame or be secured by a secure portion of the objective lens frame. The second optical member is a structure corresponding to the hollow portion. It is preferred that the second optical member is a conical-shaped structure. Wherein, the second optical member can also be a structure made of transparent plastic material.

In a preferred embodiment, the first optical beam is a pickup optical beam, and the second optical beam is a tracking optical beam. The reflective members are concave lens structures. Wherein, the concave lens structures are formed on an objective lens frame, and each of the concave lens structures comprises a reflective portion arranged in the light path of the objective lens frame facing the first optical beam, and a metal layer arranged on the reflective portion.

The refractive member is preferably a convex lens structure; and the driving member is a dither. Wherein, in an embodiment, the refractive member is an arc-shaped structure. In another embodiment, the refractive member can also be a structure whose one side is non arc-shaped and the other side is arc-shaped, and the non arc-shaped side of the refractive member is a continuous convex and concave structure.

The focusing method employing the above objective lens optical part mainly comprises the following steps: dividing the light source into a first optical beam and a second optical beam; and applying random dithering to the second optical beam. Wherein, the light source is divided into the first optical beam and the second optical beam via a first optical member and a second optical member. In a preferred embodiment, the first optical beam is a tracking optical beam, and the second optical beam is a pickup optical beam. The random dithering is performed by a tracking mechanism comprising a refractive member and a driving member. The refractive member is a convex lens, and the driving member is a dither. Wherein, in an embodiment, the first optical member and the second optical member respectively focus to the same plane of the optical recording medium; in another embodiment, the first optical member and the second optical member respectively focus to different planes of the optical recording medium.

The present invention separates the pickup optical beam from tracking optical beam, then applies random dithering to the tracking optical beam, therefore decreasing the quantization error in the course of the analog to digital conversion of the tracking error signal, thus facilitating tracking and ensuring that the pickup optical beam is arranged or projected at the center of the track.

Consequently, the present invention solves the problems of poor focusing and difficult tracking in the prior art, and provides more flexibility to the design of the objective lens, and promotes industrial usability.

Other objects, advantages and novel features of the present invention will be drawn from the following detailed description of preferred embodiments of the present invention with the appended drawings. It should be apparent to those skilled in the art that the above description is only illustrative of specific embodiments and examples of the present invention. The present invention should therefore cover various modifications and variations made to the herein-described structure and operations of the present invention, provided they fall within the scope of the present invention.

### BRIEF DESCRIPTION OF THE DRAWINGS

FIG. 1 is a schematic view of an objective lens optical part for an optical pickup device in accordance with a first embodiment of the present invention;

FIG. 2 is a schematic assembling view of a first optical member and a second optical member in the first embodiment;

FIG. 3 is a schematic view showing optical spot distributing on a track of an optical recording medium;

FIG. 4A and FIG. 4B are schematic views showing signal applied with random dithering;

FIG. 5 is a schematic view of an objective lens optical part for an optical pickup device in accordance with a second embodiment of the present invention during use;

FIG. 6A is a schematic view of an objective lens optical part for an optical pickup device in accordance with a third embodiment of the present invention during use;

FIG. 6B is a schematic view showing the positions of the optical spots generated by the optical beams of FIG. 6A;

FIG. 7 a schematic view of an objective lens optical part for an optical pickup device in accordance with a fourth embodiment of the present invention during use;

FIG. 8 is a schematic view of a conventional optical system; and

FIG. 9 is an enlarged view of the objective lens of FIG. 8.

### DETAILED DESCRIPTION OF THE PREFERRED EMBODIMENTS

The following embodiments of the present invention is exemplarily described with an objective lens optical part and a focusing method using the same employed in an optical pickup head for reading an optical recording medium in a CD system or DVD system. The structure and operating principles of the CD system, DVD system, optical recording medium, and optical pickup head are known to those skilled in the art, therefore they will not be discussed in detail below. In the mean time, the objective lens optical part for an optical pickup device and the focusing method using the same of the present invention can also employed in other systems and their corresponding optical recording medium. Consequently, the drawings showing various structures and configurations when described in relation to the following embodiments are only for illustration purposes, which shall not be construed as limitation to the present invention.

### First Embodiment

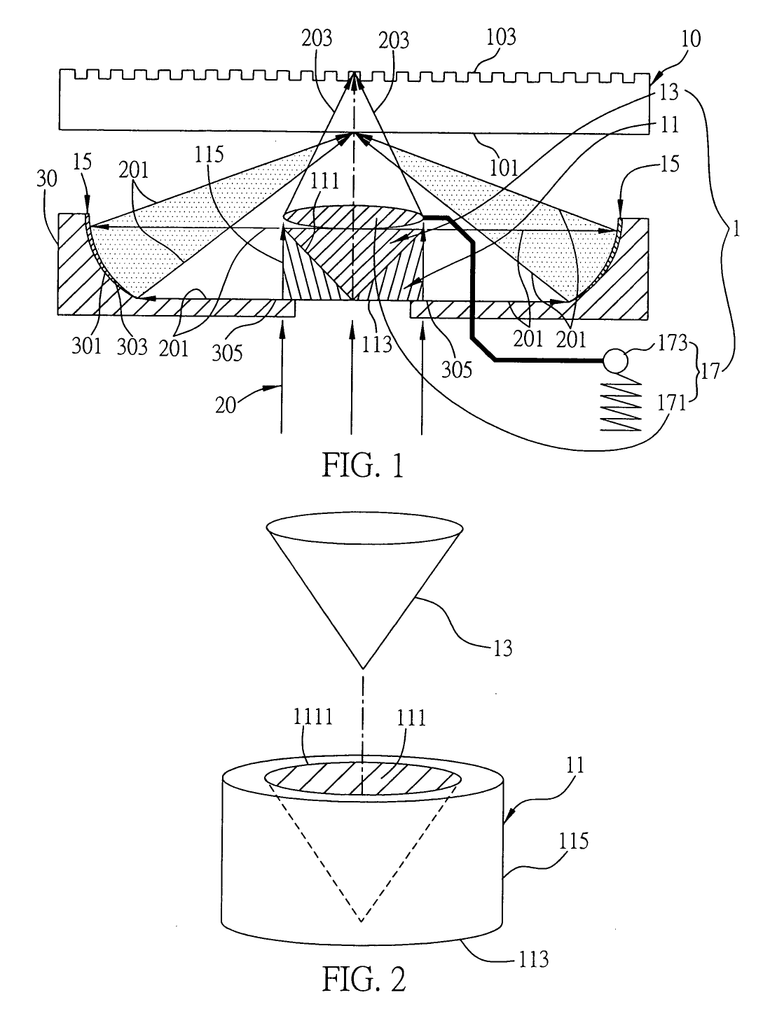

Please refer to FIG. 1 to FIG. 4B illustrating the objective lens optical part for an optical pickup device and focusing method using the same in accordance with a first embodiment of the present invention

As shown in FIG. 1, the objective lens optical part 1 is used for focusing a light source 20 to a data face 101 and track 103 of an optical recording medium 10. The objective lens optical part 1 comprises: a first optical member 11, a second optical member 13, two reflective members 15, and a tracking mechanism 17.

As shown in FIG. 2, the first optical member defines a hollow portion 111 having an opening 1111, a lateral surface 113 opposing the opening 1111, and a circumference surface 115 neighboring the lateral surface 113. The hollow portion is generally conical-shaped. The lateral surface 113 is supported by an objective lens frame 30, and at least a light source 20 passes through the lateral surface 113. The second optical member 13 is a conical-shaped structure corresponding to and arranged in the hollow portion 111, which can divide the light source 20 penetrating through the lateral surface 113 into a first optical beam 201 refracted toward the circumference surface 115 and a second optical beam 203 refracted toward the opening 1111. The first optical member 11 and second optical member 13 can be, but not limited to, structures made of transparent plastic optical material or other structures as long as the second optical member 13 can be correspondingly provided in the first optical member 11, and is able to divide the light source into the first optical beam 201 and second optical beam 203.

In the mean time, in the present embodiment, the first optical beam 201 can be a pickup optical beam, while the second optical beam 203 can be a tracking optical beam, so that the first optical beam 201 performs pickup, and the second optical beam 203 performs tracking. In addition, as shown in FIG. 1, because the focus angle of the first optical beam 201 is greater, the optical spot is thus smaller, and much more data can be picked up; while the focus angle of the second optical beam 203 is smaller, which facilitates tracking operation.

The reflective members 15 are arranged at lateral sides of the circumference surface 115, respectively, so that the first optical beam 201 focus toward the data face 101 of the optical recording medium 10. As shown in FIG. 1, the reflective members 15 can be concave lens structures formed at the objective lens frame 30. In the present embodiment, a reflective portion 301 serving as a reflecting surface can be arranged in the light path of the objective lens frame 30 facing the first optical beam 201, and the reflective portion 301 is plated with metal layer 303, therefore forming said concave lens structures; thus the propagating direction of the first optical beam 201 is changed such that the first optical beam 201 focuses onto the data face 101, and the first optical beam 201 projects on the data face 101 opposing the center of the track 103.

The tracking mechanism 17 comprises a refractive member 171 arranged between the second optical member 13 and the optical recording medium 10, and a driving member 173 connecting the refractive member 171, so that the second optical beam 203 focuses toward the track 103 of the optical recording medium 10. The refractive member 171 can be a convex lens, and the driving member 173 can be a dither. The structures and operating principles of the convex lens and the dither are conventional, therefore only the applications thereof in the present embodiment are described as follows.

As shown in FIG. 3, the optical spot 2031 of the second optical beam 203 may be located at the center 1031 of the track 103 or near the lateral side 1033 of the track 103. In the present embodiment, random dithering principle can be employed, so that the second optical beam 203 serving as the tracking optical beam keeps focusing to the center 1031 of the track 103. For example, the driving member 173 can be selected to drive the refractive member 171, such that it performs random dithering.

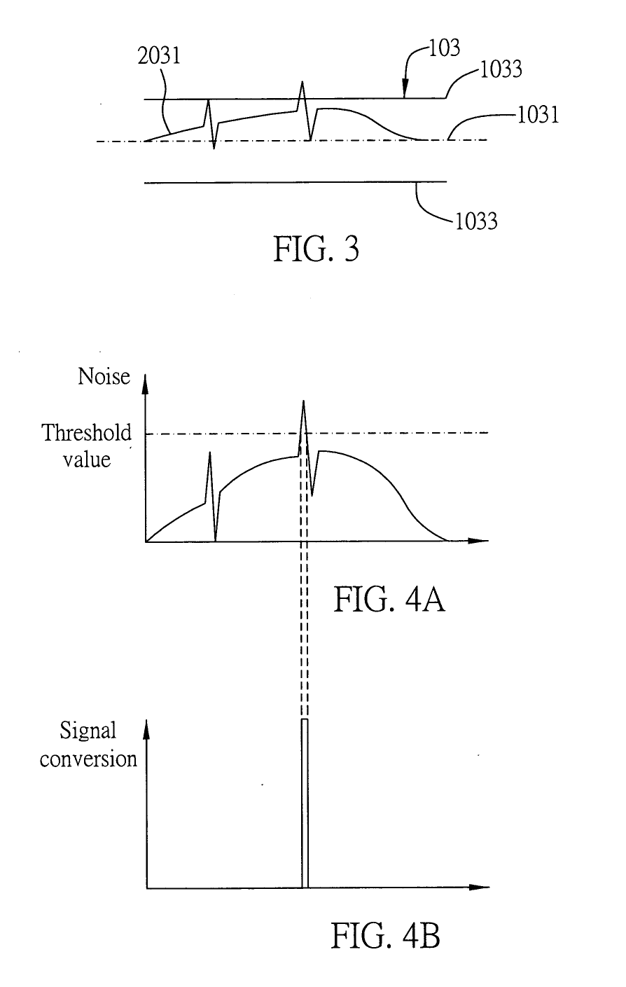

As shown in FIG. 4A, when the refractive member 171 performs random dithering, signal on the edge of the triggering signal will be forced to exceed the threshold value.

As shown in FIG. 4B, the position of the refractive member 171 can be adjusted via converting the signal exceeding the threshold value, so that the optical spot of the second optical beam 203 focused to the optical recording medium is moved back to the center of the track 103. The abovementioned random dithering is often used in image processing to decrease the quantization error generated by the employment of analog to digital converter, thus it will not be described further.

Consequently, when the optical spot of the tracking beam overly deviates from the center of the track, the objective lens optical part of the present invention can move the optical spot back to the center of the track via random dithering, so that the optical spot are reliably maintained at the center of the track.

The focusing method employing the objective lens optical part 1 mainly comprises: dividing the light source 20 into the first optical beam 201 and the second optical beam 203; and performing random dithering mechanism to the second optical beam 203. Wherein, the light source 20 is divided into the first optical beam 201 serving as the pickup optical beam and the second optical beam 203 serving as the tracking optical beam via the first optical member 11 and the second optical member 13. The random dithering is provided by the tracking mechanism 17 comprising the refractive member 171 and the driving member 173, therefore decreasing the quantization error in the course of analog to digital conversion of the tracking error signal.

Compared with conventional technology, conventional tracking is hard to perform, and is easily affected by quantization error, thus the accuracy of the tracking servo control of the optical pickup device is degraded; while in the present invention, the tracking optical beam and pickup optical beam are separated from each other, and then the tracking optical beam is applied with the random dithering mechanism, thus tracking can be easily performed, and the tracking optical beam can be maintained at the center of the track, thus further promoting the ultimate pickup quality.

### Second Embodiment

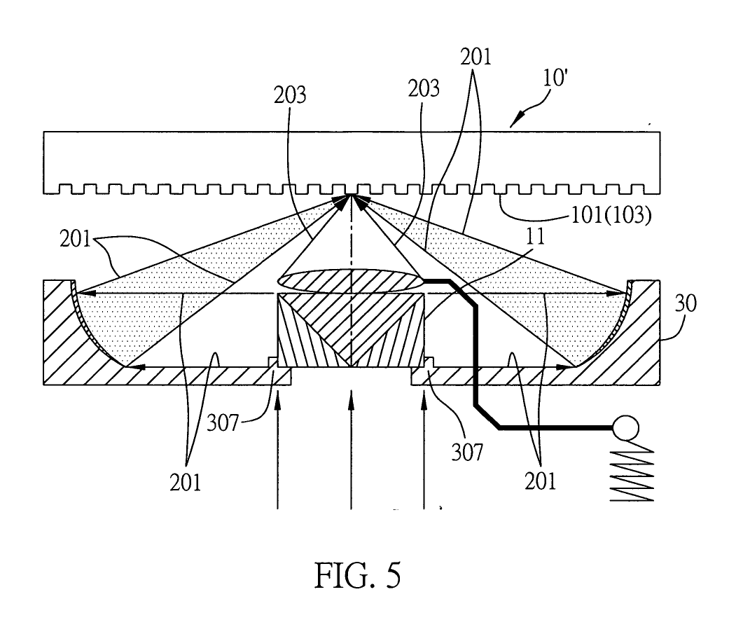

Referring to FIG. 5, a schematic view of the objective lens optical part for optical pickup device in accordance with a second embodiment of the present invention is illustrated. Wherein, components identical or similar to the first embodiment are denoted with identical or similar reference signs, whose detailed description is omitted, for simplification and clarity of the description of the present invention.

As shown in FIG. 5, the second embodiment differs from the first embodiment in that: the objective lens optical part 1 of the first embodiment is employed to focus the light source 20 to the optical recording medium 10 with the data face 101 and track 103 on different planes; while the second embodiment can be employed to the optical recording medium 10′ with the data face 101 and track 103 on the same plane.

In the mean time, the focusing method employed in the optical member of the objective lens 1 can focus the first optical beam 201 and second optical beam 203 to the same plane of the optical recording medium 10′, which is different from that of the first embodiment, which focuses on different planes of the optical recording medium 10. In other words, in the present embodiment, the first optical beam 201 is at the center of the track 103, instead of projecting on the data face 101 opposing the center of the track 103 as in first embodiment.

Consequently, the present invention can be employed in optical recording media with different structures, enhancing design flexibility. Meanwhile, the present invention can facilitate tracking and ensure the desired position of the optical beam, which not only solves the problems mentioned in the prior art, but also enhances the design flexibility and further promote industrial usability.

### Third Embodiment

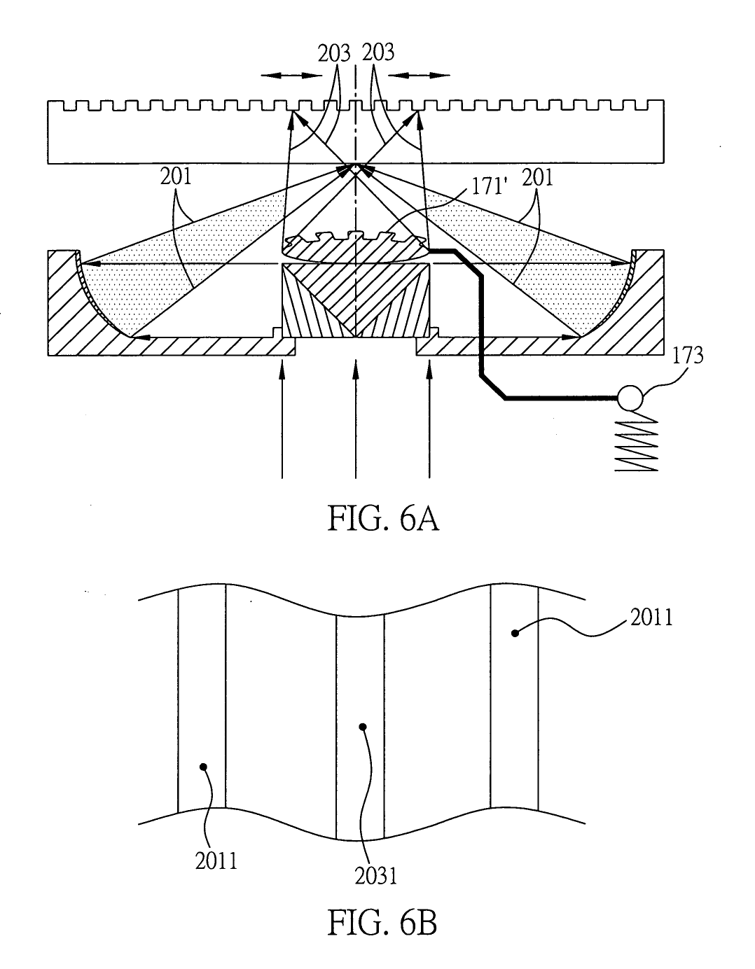

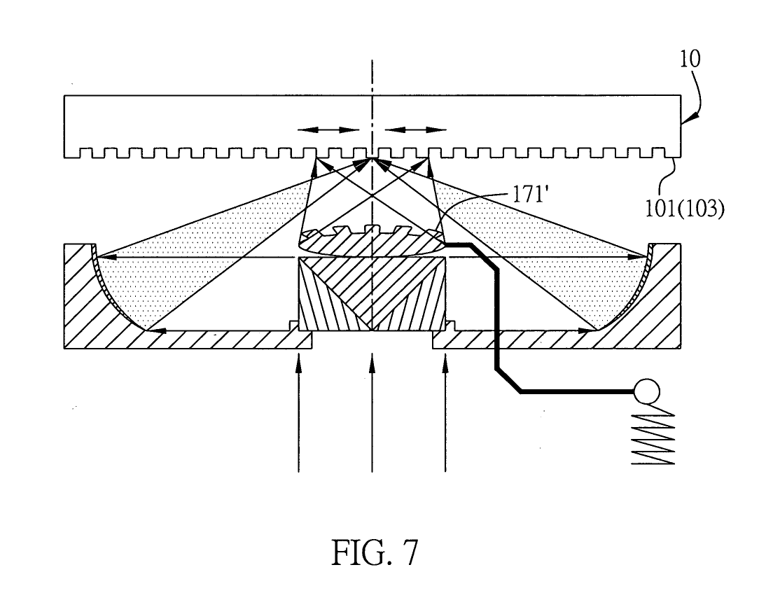

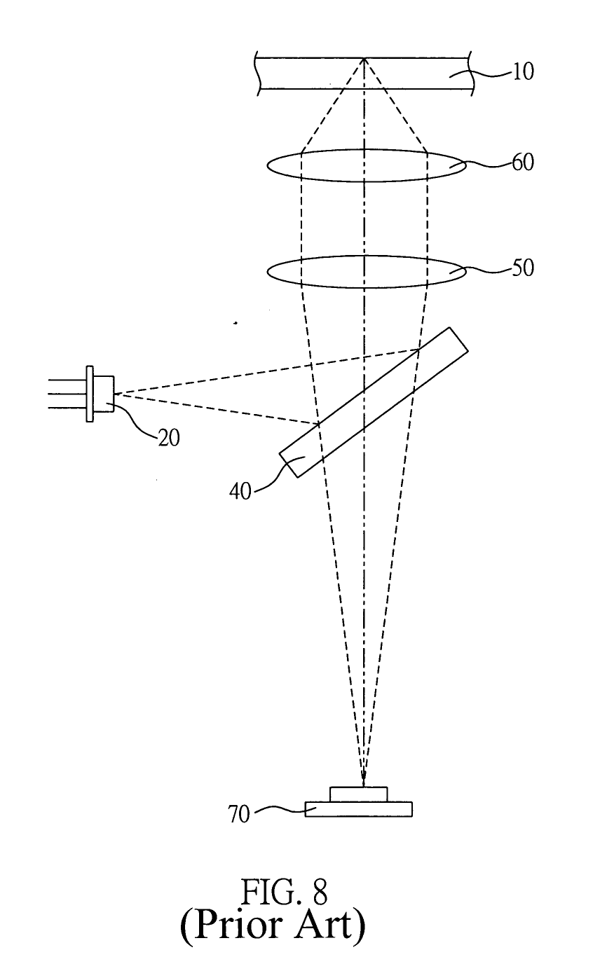

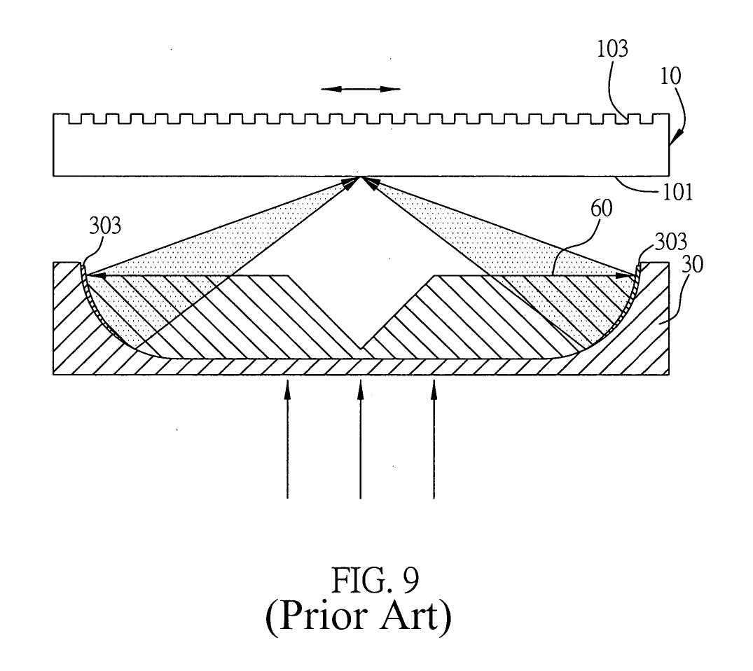

FIG. 6A and FIG. 6B are figures illustrating a third embodiment of the present invention. Wherein, components identical or similar to the previous embodiments are denoted with identical or similar reference signs, whose detailed description is omitted, for the simplification and clarity of the description of the present invention.

As shown in FIG. 6A, the arc-shaped refractive member 171 of the above embodiment is changed to a refractive member 171′ whose one side is non arc-shaped, and the other side is arc-shaped. In the present embodiment, the non arc-shaped side of the refractive member 171′ can be a continuous convex and concave structure, but in other embodiment, the refractive member 171′ can also be other equivalent structures, as long as said structure can divide the light from the second optical member 15 into at least two first optical beam 201 serving as tracking optical beam.

As shown in FIG. 6B, in the present embodiment, observing from the top of the optical recording medium 10, two tracking optical spots 2011 focused by the first optical beam 201 and one pickup optical spot 2031 focused by the second optical beam 203 are formed, and the driving member 173 is selected to drive the refractive member 171′ to perform random dithering, so that the two tracking optical spot 2011 also perform random dithering.

### Fourth Embodiment

FIG. 7 is a figure illustrates a fourth embodiment of the present invention. Wherein, components identical or similar to the previous embodiments are denoted with identical or similar reference signs, whose detailed description is omitted, for simplification and clarity of the description of the present invention.

In the present embodiment, the refractive member 171′ of the third embodiment is employed, however, the objective lens optical part of the third embodiment, similar to the first embodiment, is employed to focus light sources to an optical recording medium with data face and track on different planes, while the objective lens optical part of the present embodiment, similar to the second embodiment, is employed to an optical recording medium 10 with data face 101 and track 103 on the same plane.

As can be known from the above description, the present invention can be employed to form at least a tracking optical spot, and apply random dithering to the optical spot for decreasing tracking error, so that the optical pickup device can pick up data from the optical recording medium of different structures. Consequently, the present invention not only solves the problems of conventional technology, but also provides flexibility to the design and operation.

In the mean time, although the continuous convex and concave structures is employed in the refractive member 171′ in the third embodiment, it is apparent to those skilled in the art, structures with continuous curve surface or other irregular-shaped surface can also serve as a refractive member.

In addition, the first optical member 11 of the first embodiment is arranged on extending portions 305 of the objective lens frame 30; however, in the second embodiment, positioning portions 307 can be employed to secure the first optical member 11; and, the arrangement or secure means of the first optical member 11 on the objective lens frame of the above embodiments can be interchanged, which is obvious to those skilled in the art. In other words, all of the interchanged features of the present invention in the above embodiments are within the scope of the present invention.

Consequently, the objective lens optical part for an optical pickup device and focusing method using the same of the present invention facilitate tracking and ensure the desired position of the optical beam, thereby solving the problems in the prior art, and further enhancing industrial usability and design flexibility.

It should be apparent to those skilled in the art that the above description is only illustrative of specific embodiments and examples of the present invention. The present invention should therefore cover various modifications and variations made to the herein-described structure and operations of the present invention, provided they fall within the scope of the present invention as defined in the following appended claims.

What is claimed is:

1. An objective lens optical part used to focus a light source to a data face and a track of an optical recording medium, the objective lens optical part comprising:
a first optical member comprising a hollow portion with an opening, a lateral surface opposing the opening, and a circumference surface neighboring the lateral surface, wherein the lateral surface allows at least a light source to pass through;
a second optical member arranged in the hollow portion for dividing the light source passing through the lateral surface into a first optical beam refracted toward the circumference surface and a second optical beam refracted toward a rim of the opening;
two reflective members respectively arranged at lateral sides of the circumference surface for focusing the first optical beam toward the data face of the optical recording medium; and
a tracking mechanism comprising a refractive member arranged between the second optical member and the optical recording medium, and a driving member connecting with the refractive member for focusing the second optical beam toward the track of the optical recording medium.

2. The objective lens optical part as claimed in claim 1, wherein the first optical member is a structure made of transparent plastic material.

3. The objective lens optical part as claimed in claim 1, wherein the hollow portion is a conical-shaped structure.

4. The objective lens optical part as claimed in claim 1, wherein the lateral surface of the first optical member is supported by an objective lens frame.

5. The objective lens optical part as claimed in claim 4, wherein the first optical member is arranged on an extending portion of the objective lens frame.

6. The objective lens optical part as claimed in claim 4, wherein the first optical member is secured by a secure portion of the objective lens frame.

7. The objective lens optical part as claimed in claim 1, wherein the second optical member is a structure corresponding to the hollow portion.

8. The objective lens optical part as claimed in claim 1, wherein the second optical member is a conical-shaped structure.

9. The objective lens optical part as claimed in claim 1, wherein the second optical member is a structure made of transparent plastic material.

10. The objective lens optical part as claimed in claim 1, wherein the first optical beam is a pickup optical beam.

11. The objective lens optical part as claimed in claim 1, wherein the second optical beam is a tracking optical beam.

12. The objective lens optical part as claimed in claim 1, wherein the reflective members are concave lens structures.

13. The objective lens optical part as claimed in claim 12, wherein the concave lens structures are formed on an objective lens frame.

14. The objective lens optical part as claimed in claim 13, wherein each of the concave lens structures comprises a reflective portion arranged in the light path of the objective lens frame facing the first optical beam, and a metal layer arranged on the reflective portion.

15. The objective lens optical part as claimed in claim 1, wherein the refractive member is a convex lens structure.

16. The objective lens optical part as claimed in claim 1, wherein the refractive member is an arc-shaped structure.

17. The objective lens optical part as claimed in claim 1, wherein the refractive member is a structure whose one side is non arc-shaped and the other side is arc-shaped.

18. The objective lens optical part as claimed in claim 17, wherein the non arc-shaped side of the refractive member is a continuous convex and concave structure.

19. The objective lens optical part as claimed in claim 1, wherein the driving member is a dither.

20. A focusing method utilizing the objective lens optical part as claimed in claim 1 for focusing a light source to a data face and a track of an optical recording medium, the focusing method comprising:
dividing the light source into a first optical beam and a second optical beam; and
applying a random dithering mechanism to the second optical beam.

21. The focusing method as claimed in claim 20, wherein the first optical beam is a tracking optical beam.

22. The focusing method as claimed in claim 20, wherein the second optical beam is a pickup optical beam.

23. The focusing method as claimed in claim 20, wherein the light source is divided into the first optical beam and the second optical beam via a first optical member and a second optical member.

24. The focusing method as claimed in claim 23, wherein the first optical member and the second optical member respectively focus to the same plane of the optical recording medium.

25. The focusing method as claimed in claim 23, wherein the first optical member and the second optical member respectively focus to different planes of the optical recording medium.

26. The focusing method as claimed in claim 23, wherein the first optical member is made of transparent plastic material.

27. The focusing method as claimed in claim 23, wherein the second optical member is made of transparent plastic material.

28. The focusing method as claimed in claim 20, wherein the random dithering mechanism is performed by a tracking mechanism comprising a refractive member and a driving member.

29. The focusing method as claimed in claim 28, wherein the refractive member is a convex lens.

30. The focusing method as claimed in claim 28, wherein the driving member is a dither.

31. The objective lens optical part as claimed in claim 7, wherein the second optical member is a conical-shaped structure
